(19) United States
(12) Patent Application Publication
(10) Pub. No.: US 2006/0121941 A1
(43) Pub. Date: Jun. 8, 2006

(54) SIM card retaining device

(76) Inventor: Jamie C. Shiflett, Durham, NC (US)

Correspondence Address: COATS & BENNETT/SONY ERICSSON, 1400 CRESCENT GREEN, SUITE 300, CARY, NC, 27511, US

(21) Appl. No.: 11/003,113

(22) Filed: Dec. 3, 2004

(51) Int. Cl. H04M 1/00

(52) U.S. Cl. 455/558; 455/575.1

(57) ABSTRACT

A device to retain a SIM card in an opening comprises an RF shield having one or more retaining members integrally formed with RF shield. The RF shield is disposed in spaced relation to a printed circuit board to define an opening that receives the SIM card may be inserted. When the SIM card is inserted into the opening, the one or more retaining members press on a surface of the SIM card. This forces an opposing surface of the inserted SIM card into electrical contact with a contact disposed on the printed circuit board, and retains the SIM card in the opening.

### BACKGROUND

The present invention relates generally to wireless communications devices, and particularly to wireless communications devices that use SIM cards.

A Subscriber Identity Module (SIM) is a small card-like device that stores information used to identify a mobile subscriber. In addition, SIM cards may also store other user information such as text messages and entries for a phone book. Because of their small, standardized size, subsribers can easily transfer their SIM card between cellular telephones simply by removing it from one phone and intstalling it into another. In this manner, subscribers can easily move their wireless account from one cellular telephone to another without losing their information and, in some cases, without having to change phone numbers. SIMs are most widely used in cellular telephones that communicate over GSM wireless communications systems, but compatible modules are available for other systems as well,..such as Universal Mobile Telecommunications System (UMTS).

The Personal Computer Memory Card International Association (PCMCIA) is an industry trade association that creates standards for computer peripheral devices. Perhaps one of the most widely known and used devices is a PC card (also known as a PCMCIA card), although recent developments have led to even smaller devices known as NewCards, ExpressCards, and Mini ExpressCards. Originally, these devices were used to expand the memory of a computing device. However, some devices now permit subscribers to employ their notebook or laptop computing devices as cellular communications devices. In these cases, a subscriber may simply mate his or her SIM card with a PC card, for example, in order to register with and communicate over a wireless communications system.

Most wireless communications devices that use SIMs (e.g., cellular telephones, laptop/notebook computers having PC cards) typically have some kind of retention mechanism that prevents the SIM from falling out of its slot once it is inserted. Conventional retention mechanisms have included spring-loaded clips that slide over a surface of the SIM once the SIM is installed. However, these comprise movable parts that may break and represent additional manufacturing costs. Accordingly, a new method of retaining SIMs in devices such as PC cards is needed.

### SUMMARY

The present invention discloses a mechanism that retains a SIM used in a wireless communication device. In one embodiment, a communications assembly comprises a printed circuit board and an RF shield. The printed circuit board includes circuitry that permits a user to communicate over a wireless communications system, and a SIM contact. The RF shield includes one or more retaining members integrally formed on and extending from a surface of the RF shield. When assembled, the RF shield is disposed in spaced relation to a surface of the printed circuit board having the SIM contact. This defines an opening that slidingly receives the SIM.

When the SIM is inserted into the opening, the one or more retaining members formed on the surface of the RF shield exert a pressing force on a surface of the SIM. This presses contacts on an opposing surface of the SIM into electrical contact with the SIM contact disposed on the surface of the printed circuit board. It also applies a tension force that resists the removal of the SIM through the opening thereby protecting the SIM card against inadvertent removal. To remove the SIM, a subscriber places a finger into an indentation formed in the RF shield and manually pushes on one edge of the SIM. Once the subscriber's pushing force overcomes the tension force exerted on the SIM by the retaining members, the SIM moves back through the opening.

### BRIEF DESCRIPTION OF THE DRAWINGS

FIG. 1 illustrates an exploded view of one embodiment of the communications assembly according to one embodiment of the present invention.

FIG. 2 illustrates a perspective view of an assembled communications assembly according to one embodiment of the present invention where the SIM is extracted from the assembly.

FIG. 3 illustrates a perspective view of an assembled communications assembly according to one embodiment of the present invention where the SIM is inserted into the assembly.

FIG. 4A illustrates a perspective view of an RF shield according to one embodiment of the present invention.

FIG. 4B illustrates a perspective view of an indentation formed in the RF shield that permits a subscriber to extract the SIM from the communications assembly according to one embodiment of the present invention.

FIG. 4C illustrates a perspective edge view of the communications assembly to illustrate a retaining member according to one embodiment of the present invention.

FIGS. 5A and 5B illustrate perspective views of the RF shield and communications assembly to illustrate a retaining member according to an alternate embodiment of the present invention.

FIGS. 6A and 6B illustrate perspective views of the RF shield and communications assembly to illustrate a retaining member according to another alternate embodiment of the present invention.

FIGS. 7A and 7B illustrate perspective views of the RF shield and communications assembly to illustrate a retaining member according to yet another alternate embodiment of the present invention.

FIG. 8 illustrates a wireless communications over which a subscriber may communicate using a computing device configured according to one embodiment of the present invention.

### DETAILED DESCRIPTION

Turning now to the Figures, a communications assembly according to one embodiment of the present invention is shown therein and indicated generally by the number 10. The figures and the following description refer to the assembly as a PC card 10. As used herein, the term “PC card” refers generally to a plug-in type card assembly, such as PCMCIA cards, PC cards, NewCards, ExpressCards, and Mini ExpressCards, that may be used to facilitate communications in computing devices. However, those skilled in the art will appreciate that the present invention may be used in any communications card assembly capable of receiving a SIM.

PC card 10 comprises an RF shield 20 and a printed circuit board (PCB) 40. PCB 40 comprises communications circuitry 42, one or more contacts 44, and a SIM contact 46. Other electrical components may or may not be included on PCB 40 as is known in the art. Communications circuitry 42 permits a device, such as a laptop computing device, to communicate with remote parties over a wireless communications system. Subscribers may slidingly insert a SIM card 50 or like device into PC card 10 such that contacts on a surface of SIM 50 come into electrical contact with SIM contact 46 disposed on a surface of PCB 40. A communications program or other software included on the subscriber's device may then send and receive messages to register and/or authenticate the subscriber with the wireless communications system as is known in the art. Once registered and/or authenticated, the subscriber may dial the phone numbers to place outgoing calls or recive incoming calls as is known in the art.

Communications circuitry 42 may include a variety of electronic components that, in concert with other electronic components, permit a subscriber to transmit and receive cellular signals to and from one or more base stations (not shown) in the wireless communications network. Communications circuitry 42 may operate according to any known standard, including but not limited to Global System for Mobile Communications (GSM), TIA/EIA-136, cdmaOne, cdma2000, UMTS, and Wideband CDMA.

SIM 50, as stated above, is a small, card-like device that may comprise a controller, memory, and I/O circuits as known in the art. Typically, SIM 50 performs most if not all operations necessary for communications based on information it stores in memory. This information includes, but is not limited to, information used to identify a mobile subscriber during the registration and authorization process, user-defined data such as a phone book, and text messages. The size of a slot in which SIM 50 may be inserted is standardized by GSM standards. Some SIMs may be as small as 25 mm×15 mm. This small, standardized size permits subsribers to easily transfer SIM 50 between PC cards 10 simply by removing it from one PC card 10 and intstalling it into another.

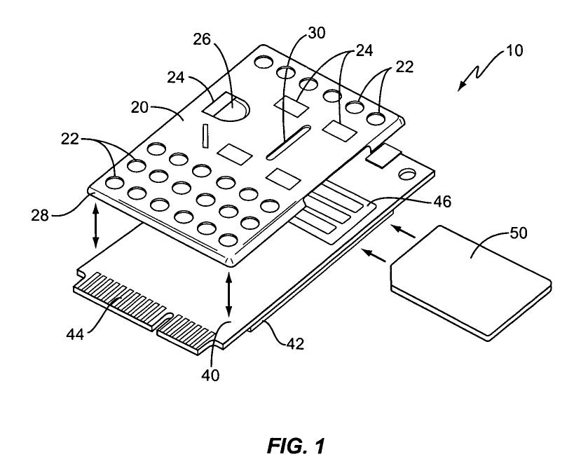

RF shield 20, according to one embodiment of the present invention, is a metallic, unitary structure that prevents RF leakage from PC card 10. It also protects circuitry on PC card 10 from electrical noise that may be generated from any adjacent electrical components disposed in a subscriber's wireless communications device. As seen in FIG. 1, RF shield 20 may include one or more holes 22, one or more windows 24, an indentation 26, a sidewall 28, and a retaining member 30.

Holes 22 generally are cutouts in the RF shield 20. Holes 22 provide ventilation and airflow for electrical components disposed on a surface of PCB 40, as well as allow persons or equipment to access the components both during and after the manufacturing process. Windows 24 are also cutouts in RF shield 20, and permit users to visually see a portion of a SIM card 50 when it is inserted into the PC card 10. Indentation 26 is integrally formed with RF shield 20, and may or may not be placed adjacent one edge of a window 24. Indentation 26 is generally sized to receive a portion of a subscriber's finger. A subscriber wishing to remove an inserted SIM 50 may place his or her finger into indentation 26, and manually apply a force to an edge of SIM 50 to push or slide SIM 50 out of PC card 10.

RF shield 20 may also include a sidewall 28 that extends generally perpendicularly from the periphery of RF shield 20. When assembled, sidewall 28 contacts a surface of PCB 40. As will be described later in more detail, sidewall 28 maintains RF shield in spaced relation to PCB 40 to define an opening through which SIM 50 may be inserted and removed. It should be noted that the Figures illustrate sidewall 28 as extending substantially completely around the periphery of RF shield 20. However, this particular configuration is not required. Sidewall 28 may extend only partially around the periphery of RF shield 20, or it may extend completely around RF shield 20. In addition, RF shield 20 may include more than one sidewall 28, or may include posts or other like components to maintain RF shield in spaced relation to PCB 40.

Retaining member 30 is integrally formed with RF shield 20, such that retaining member 30 and RF shield 20 form a unitary structure. In this embodiment, retaining member 30 is stamped or pressed into RF shield 20 such that it forms a depression in RF shield 20. However, this is not required as the present invention also contemplates an embodiment where retaining member 30 is a component that is distinct from RF shield 20. In embodiments where retaining member 30 and RF shield are separate components, which is shown and described in later figures, retaining member 30 is attached or otherwise connected to a surface of RF shield 20 during manufacture. This may be accomplished by any method known in the art, for example, by soldering or gluing retaining member 30 to the surface of RF shield 20. As used herein, retaining member 30 is “integrally” formed with RF shield 20 regardless of whether retaining member 30 is formed as a depression or indentation in RF shield 20, or is separate from and later connected to RF shield 20.

According to the present invention, retaining member 30 extends from a surface of RF shield 20 towards SIM contact 46 disposed on PCB 40. In one embodiment, retaining member 30 is sized such that it is approximately 0.005 inches or less than the height of RF shield 20; however, these dimensions are for illustrative purposes only. Regardless of its size and/or dimensions, retaining member 30 extends towards PCB 40 such that the distance beween SIM contact 46 and retaining member 30 is generally less than the height of SIM 50. This permits retaining member 30 to provide a resistance against inserting and extracting SIM 50 from PC card 10. It also provides a pressing force on a surface of an inserted SIM 50 so that a contact on an opposing surface of SIM 50 maintains good electrical contact with SIM contact 46 on PCB 40. In addition, this also permits retaining member 30 to exert tension on the inserted SIM 50 to prevent SIM 50 from being inadvertantly extracted from PC card 10.

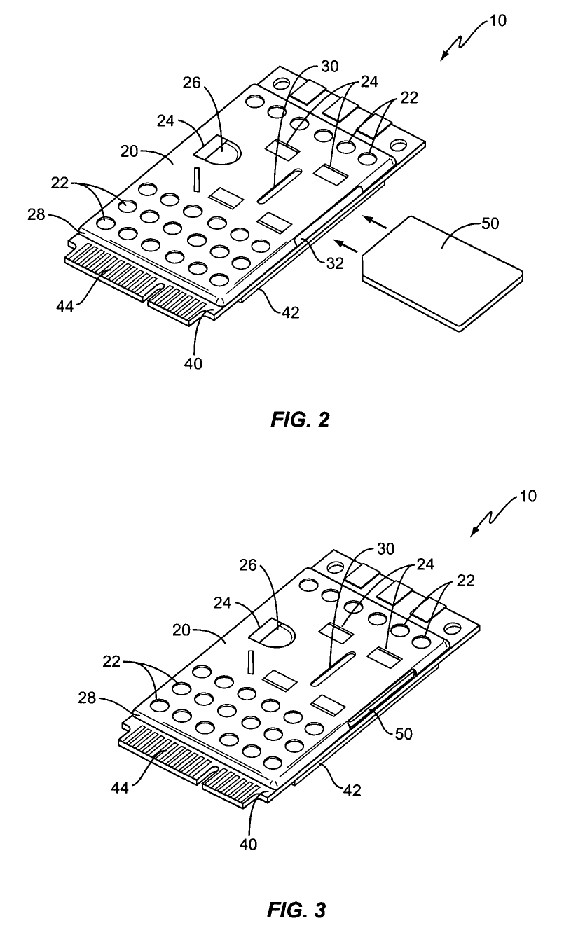

FIGS. 2 and 3 illustrate one embodiment of the present invention wherein RF shield 20 and PCB 40 are assembled to form PC card 10. When assembled, PC card 10 is approximately the size of a credit card. Currently, different sizes of PC cards 10 exist—each varying in thickness. Type I cards, for example, are approximately 3.3 mm thick, while type II and type III cards are approximately 5.0 mm thich and 10.5 mm thick, respectively. Regardless of the type of card, most PC cards 10 are 85.6 mm long and 54.0 mm wide, although any size and/or dimension may be used as desired.

When assembled, PC card 10 may be inserted into a subscriber's wireless communications device by mating contacts 44 with a corresponding slot in the communications device. While not specifically shown in the Figures, these corresponding slots typically connect PC card 10 to a PCMCIA type bus. Depending upon the number and type of contacts 44, PC card 10 may mate with a 16-bit bus, or a 32-bit bus, such as the 32-bit 33 MHz PCI bus available in many of today's notebook and laptop computers. However, those skilled in the art will readily appreciate that these aforementioned busses are merely illustrative, and a PC card 10 configured according to the present invention may mate with and communicate signals over any known bus.

As seen in FIGS. 2 and 3, RF shield 20 is in spaced relation to PCB 40. This defines an opening 32 that receives SIM 50. Thus, SIM 50 may be slidingly inserted through opening 32 (FIG. 3), and slidingly removed through opening 32 (FIG. 2). The dimensions of opening 32 may be any size desired; however, in one embodiment, opening 32 conforms to the size specified by GSM standards. When SIM 50 is inserted into opening 32, retaining member 30 exerts a force on the surface of the inserted SIM 50 to retain SIM 50 in the opening 32 and against the SIM contact 46. To remove SIM 50, the subscriber needs only to place a finger, for example, into indentation 26 and apply a force to the edge of SIM 50 to slide SIM 50 back through the opening 32.

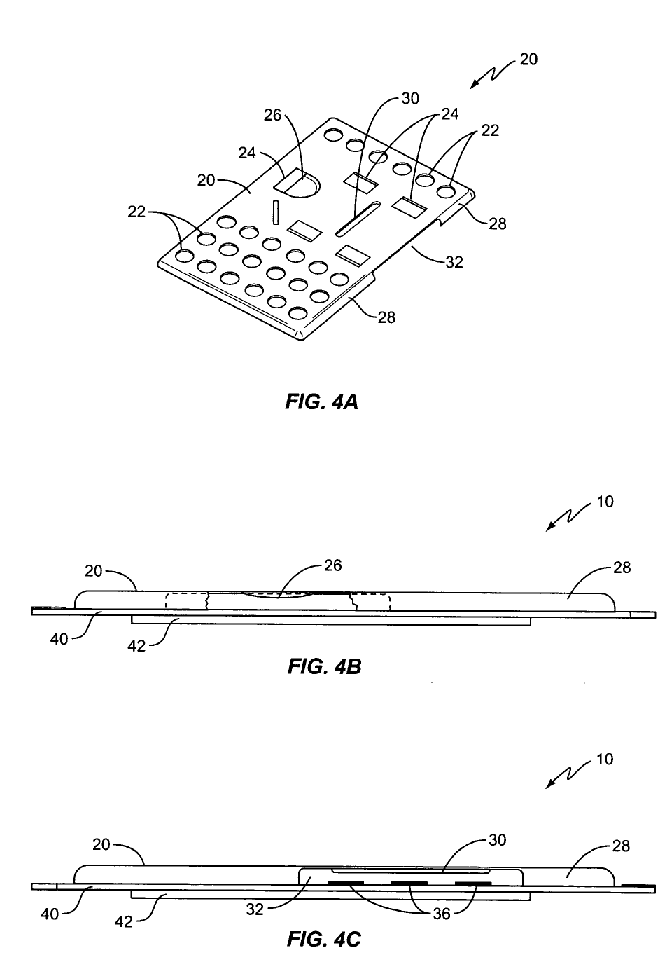

FIGS. 4A-4C illustrate perspective views of the RF shield 20, the indentation 26, and the retaining member 30, respectively. As seen in FIGS. 4A and 4B, indentation 26 is formed as a depression in RF shield 20. Likewise, FIGS. 4A and 4C illustrate retaining member 30 as being formed as a depression across a length of RF shield 20. In this embodiment, however, indentation 26 differs from retaining member 30 in that indentation 26 allows a finger to extend through RF shield 20 to contact the edge of SIM 50 when SIM 50 is inserted through opening 32.

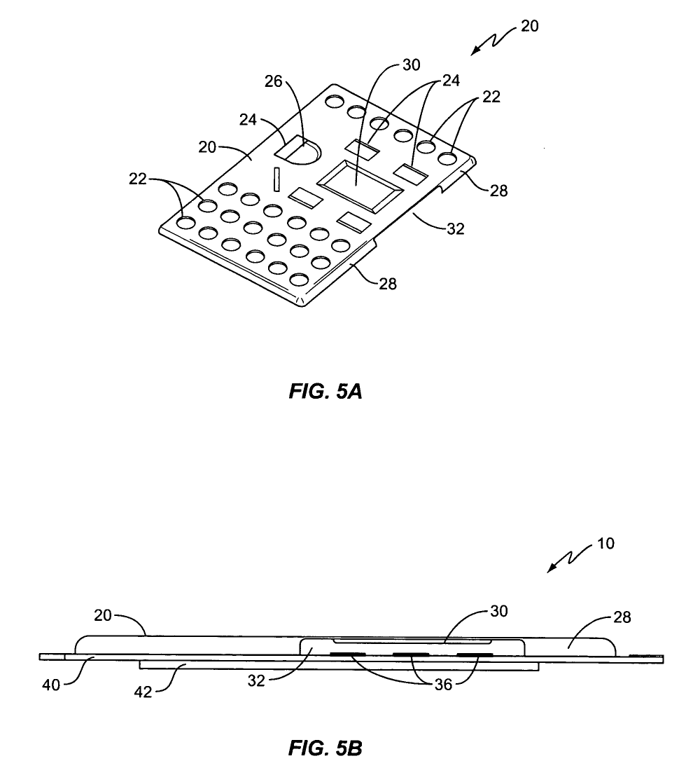

FIGS. 5A and 5B illustrate an alternate embodiment of the present invention. In this embodiment, retaining member 30, while still being formed integrally with RF shield 20, contacts a greater surface area of SIM 50 when SIM 50 is inserted into opening 32. It should be noted that in this embodiment, retaining member 30 still exerts a force on the surface of SIM 50 that retains SIM 50 in the opening 32, and causes the contact disposed on the opposing surface of SIM 50 to maintain good electrical contact with SIM contact 46.

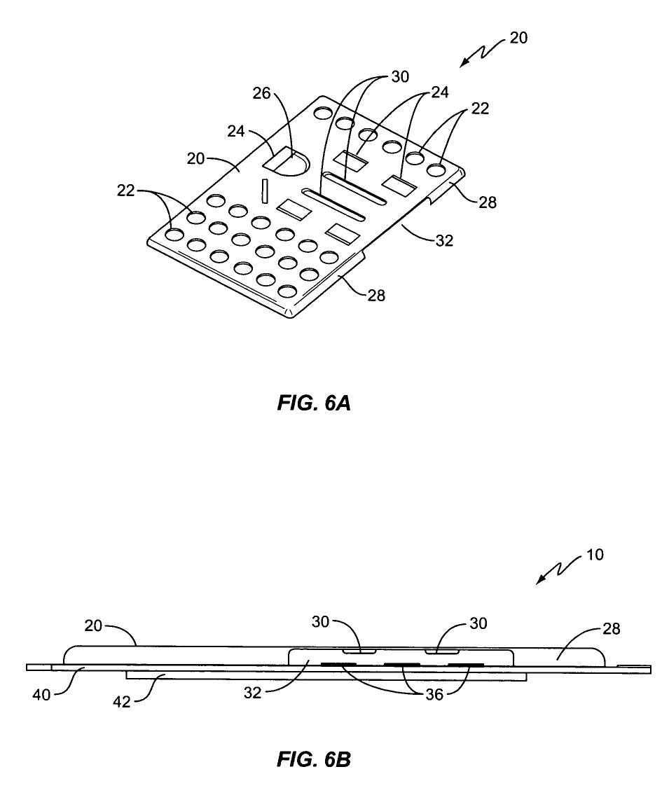

FIGS. 6A and 6B illustrate another alternate embodiment wherein RF shield 20 includes a plurality of retaining members 30 formed integrally with RF shield 20. In this embodiment, retaining members 30 are formed as depressions such that they contact the inserted SIM 50 proximate either edge of SIM 50. This permits retaining members 30 to exert the force on the surface of SIM 50 more evenly. As in the previous embodiments, retaining members 30 exert a force on the surface of inserted SIM 50 to retain SIM 50 in the opening 32. The exerted force also causes contacts on the opposing surface of SIM 50 to maintain good electrical contact with SIM contact 46 disposed on PCB 40.

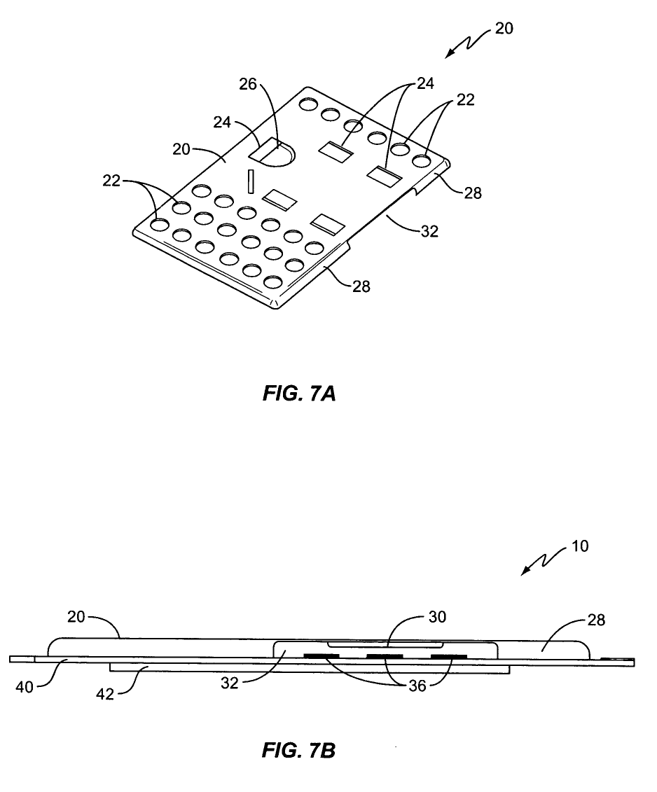

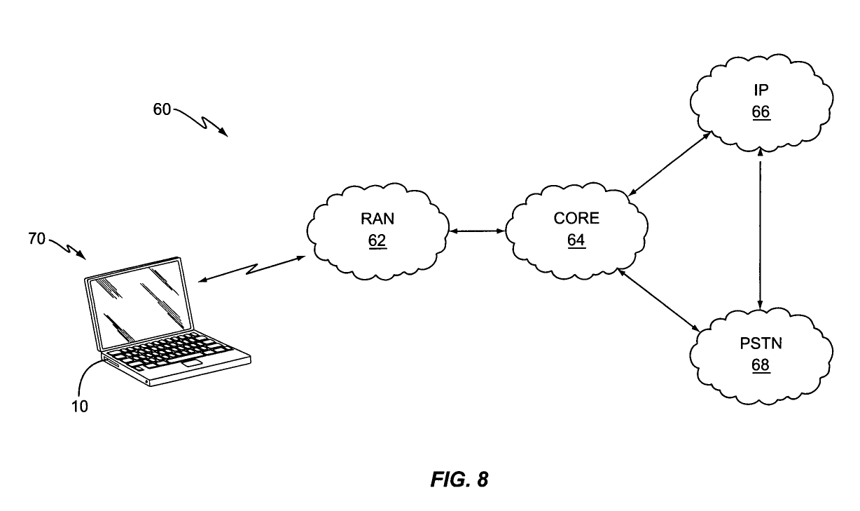

As previously noted, it is not necessary for the retaining members 30 to be formed as depressions in RF shield 20. Retaining member 30 may be separate components that are soldered, glued, or otherwise attached to an undersurface of RF shield 20 during the manufacturing process. As seen in FIG. 7A, the top surface of RF shield 20 does not include a depression. FIG. 7B, however, illustrates retaining member 30 attached to the undersurface of RF shield 20. Regardless of how retaining member 30 is formed, it remains integral with RF shield 20, and exerts a force on SIM 50 as stated above.

FIG. 8 illustrates one possible network configuration 60 in which a wireless communications device including PC card 10 of the present invention may operate. In this embodiment, PC card 10 having SIM 50 inserted therein is included in a notebook computing device 70. The subscriber may communicate with remote parties via a Radio Access Network (RAN) 62, which may be, for example, a GSM network. RAN 62 also interconnects device 70 to a Core network 64 to provide the subscriber with packet data services as is known in the art. Core network 64 further connects device 70 to an IP network 66, such as the Internet, and a public circuit-switched network, such as PSTN 68.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A communications assembly for a wireless communications device comprising:
a printed circuit board having a SIM contact disposed thereon;
an RF shield disposed in spaced relation to the printed circuit board to define an opening to receive a SIM card; and
a retaining member integral with and extending from a surface of the RF shield to retain the SIM card against the contact.

2. The assembly of claim 1 wherein the RF shield includes a sidewall that extends to contact a surface of the printed circuit board.

3. The assembly of claim 1 wherein the retaining member exerts a force on a surface of the SIM card to retain an opposing surface of the SIM card against the contact.

4. The assembly of claim 3 wherein the retaining member comprises one or more depressions integrally formed with the RF shield.

5. The assembly of claim 3 wherein the retaining member comprises one or more extending members connected to the surface of the RF shield.

6. The assembly of claim 3 further comprising a plurality of retaining members to exert a force on the surface of the SIM card to retain the opposing surface of the SIM card against the contact.

7. The assembly of claim 1 further comprising an indentation integrally formed in the RF shield to permit a user to remove the SIM card from the opening.

8. The assembly of claim 1 wherein the assembly comprises a PCMCIA card.

9. The assembly of claim 1 wherein the assembly comprises a PCI Express card.

10. The assembly of claim 1 wherein the assembly comprises a PCI MiniExpress card.

11. A RF shield for a communications assembly in a wireless communications device, the RF shield comprising:
first and second opposing surfaces;
a sidewall to dispose the second surface in spaced relation to a printed circuit board and define an opening to receive a SIM card; and
one or more retaining members integral with and extending from the second surface to retain the SIM card against a contact disposed on the printed circuit board.

12. The RF shield of claim 11 wherein the sidewall extends to contact the printed circuit board.

13. The RF shield of claim 11 wherein the one or more retaining members exert a force on a surface of the SIM card to retain an opposing surface of the SIM card against the contact.

14. The RF shield of claim 13 wherein the one or more retaining members are depressions integrally formed with the RF shield.

15. The RF shield of claim 13 wherein the one or more retaining members comprise one or more extending members connected to the second surface of the RF shield.

16. The RF shield of claim 11 further comprising an indentation integrally formed in the RF shield to permit a user to remove the SIM card from the opening.

17. A wireless communications device comprising:
communications circuitry to facilitate communications with a wireless communications network; and
a plug-in communications card including:
a printed circuit board having a SIM contact disposed thereon;
an RF shield disposed in spaced relation to the printed circuit board to define an opening to receive a SIM card; and
one or more retaining members integral with and extending from the RF shield to retain the SIM card in the opening.

18. The wireless communications device of claim 17 wherein the RF shield includes a sidewall that extends to contact a surface of the printed circuit board.

19. The wireless communications device of claim 17 wherein the one or more retaining members exert a force on a surface of the SIM card that retains an opposing surface of the SIM card against the SIM contact.

20. The wireless communications device of claim 19 wherein the one or more retaining members are depressions integrally formed with the RF shield.

21. The wireless communications device of claim 19 wherein the one or more retaining members comprise one or more extending members connected to the second surface of the RF shield.

22. The wireless communications device of claim 17 further comprising an indentation integrally formed with the RF shield to permit a user to extract the SIM card from the opening.

23. The wireless communications device of claim 17 wherein the plug-in card comprises a PCMCIA card.

24. The wireless communications device of claim 17 wherein the plug-in card comprises a PCI Express card.

25. The wireless communications device of claim 17 wherein the plug-in card comprises a PCI MiniExpress card.

26. A method of communicating with a wireless communications device having a SIM card, the method comprising:
extending one or more retaining members from a surface of an RF shield;
disposing the RF shield in spaced relation to a printed circuit board to define an opening to receive a SIM card; and
using the one or more retaining members to retain the SIM card against a contact disposed on the printed circuit board when the SIM card is inserted into the opening.

27. The method of claim 26 wherein extending one or more retaining members from a surface of an RF shield comprises integrally forming the one or more retaining members as depressions in the RF shield.

28. The method of claim 26 wherein extending one or more retaining members from a surface of an RF shield comprises connecting the retaining members to the surface of the RF shield.

29. The method of claim 26 wherein disposing the RF shield in spaced relation to a printed circuit board comprises contacting a surface of the printed circuit board with a sidewall that extends from the periphery of the RF shield.

30. The method of claim 26 wherein disposing the RF shield in spaced relation to a printed circuit board comprises disposing the one or more retaining members in spaced relation to the contact.

31. The method of claim 26 wherein using the one or more retaining members to retain the SIM card against a contact comprises pressing a surface of the SIM card with the one or more retaining members to force an opposing surface of the SIM card against the contact.

32. The assembly of claim 26 further comprising integrally forming an indentation in the RF shield to permit a user to remove the SIM card from the opening.
